(19) United States
(12) Patent Application Publication
(10) Pub. No.: US 2014/0254491 A1
(43) Pub. Date: Sep. 11, 2014

(54) HOME ROUTING FOR IMS ROAMING USING VPLMN ANCHOR

(71) Applicants: Fredrik Lindholm, Stockholm (SE); Gert Oster, Jarfalla (SE)

(72) Inventors: Fredrik Lindholm, Stockholm (SE); Gert Oster, Jarfalla (SE)

(73) Assignee: TELEFONAKTIEBOLAGET L M ERICSSON (PUBL), Stockholm (SE)

(21) Appl. No.: 14/342,370

(22) PCT Filed: Aug. 30, 2012
(86) PCT No.: PCT/EP2012/066924

§ 371 Date: May 9, 2014

Related U.S. Application Data
(60) Provisional application No. 61/529,423, filed on Aug. 31, 2011.

(51) Int. Cl. H04W 8/04; H04L 29/06

(52) U.S. Cl. CPC H04W 8/04; H04L 65/1006; H04L 65/1016; H04L 65/1069
USPC 370/328

(57) ABSTRACT

Methods and apparatus are described for use in handling session establishment in a home network or visited network. IMS roaming is described for a UE of the home network that is roaming in the visited network. On receipt of a session establishment request associated with an originating call from the UE the home network determines whether to perform home routing and/or direct home routing of the originating call to the called party. When home routing, execution of service invocation is suspended and the home network sends a session establishment request including a routing number of an application server in the home network back to the visited network, which performs visiting service invocation of the call and routes the signaling and media to the home network-based on the routing number. The network node in the home network resumes execution of service invocation and routing of the originating call to the called party. When direct home routing, the home network performs execution of service invocation and routes the originating call to the called party.

### TECHNICAL FIELD

The present invention relates to methods and apparatus for handling Internet Multimedia Subsystem (IMS) session establishment for an originating call from a user equipment (UE) in an access network the UE is visiting. In particular, the invention relates to methods and apparatus for anchoring the originating call in the home network associated with the UE when it is determined to perform home network roaming via the access network or direct home roaming.

### BACKGROUND

IP Multimedia services provide a dynamic combination of voice, video, messaging, data, etc. within the same session. By growing the number of basic applications and the media which it is possible to combine, the number of services offered to the end subscribers will grow, and the inter-personal communication experience will be enriched. This will lead to a new generation of personalised, rich multimedia communication services, including so-called “combinational IP Multimedia” services.

IP Multimedia Subsystem (IMS) is the technology defined by the Third Generation Partnership Project (3GPP) and ETSI TISPAN group to provide IP Multimedia services over mobile communication networks. IMS provides key features to enrich the end-subscriber person-to-person communication experience through the use of standardised IMS Service Enablers, which facilitate new rich person-to-person (client-to-client) communication services as well as person-to-content (client-to-server) services over IP-based networks. The IMS makes use of the Session Initiation Protocol (SIP) to set up and control calls or sessions between subscriber terminals (or subscriber terminals and application servers). The Session Description Protocol (SDP), carried by SIP signalling, is used to describe and negotiate the media components of the session. Whilst SIP was created as a subscriber-to-subscriber protocol, IMS allows operators and service providers to control subscriber access to services and to charge subscribers accordingly.

By way of example, FIG. 1 illustrates schematically a telecommunications network showing an example of the IMS network architecture used for roaming users when they place a call in a visited access network such as a Visited Public Land Mobile Network (VPLMN). In this example, a calling party A (or UE A) is visiting the VPLMN for party A (also referred to as Visited A, VPLMN A or Visited operator for party A) and places a call to a called party B visiting VPLMN for party B (Visited B or VPLMN B). Each access network or PLMN includes some IMS architecture such as Interconnection Border Control Function (IBCF) or Translation Gateway nodes (TrGw) that connect the PLMNs with each other via core networks for example those based on Internetwork Packet Exchange (IPX) 1, 2, 3 and 4. An IBCF is an interconnecting gateway between an IMS network and other IP networks e.g. other IMS networks or core networks etc. Each PLMN includes some IMS architecture such as registrar nodes associated with the various access domains (or networks) such as Call/Session Control Functions (CSCFs), which operate as SIP proxies within the IMS. The 3GPP architecture defines three types of CSCFs: the Proxy CSCF (P-CSCF) which is the first point of contact within the IMS for a SIP terminal i.e. calling party A; the Serving CSCF (S-CSCF) (not shown in VPLMN) which provides services to the subscriber that the subscriber is subscribed to; and the Interrogating CSCF (I-CSCF) whose role is to identify the correct S-CSCF and to forward to that S-CSCF a request received from a SIP terminal via a P-CSCF.

Within the IMS network architecture, Application Servers (ASs) are provided for implementing IMS service functionality. ASs provide services to end users in an IMS system, and may be connected either as end-points over the 3GPP defined Mr interface, or “linked in” by an S-CSCF over the 3GPP defined IMS Service Control (ISC) interface. In the latter case, Initial Filter Criteria (IFC) are used by an S-CSCF to determine which ASs should be “linked in” during a SIP Session establishment (or indeed for the purpose of any SIP method, session or non-session related). The IFCs are received by the S-CSCF from a home subscriber server (HSS) during the IMS registration procedure as part of a user's or subscriber's Subscriber Profile.

The user equipment (UE) for a calling or called party may comprise or represent any device used for communications. Examples of user equipment that may be used in certain embodiments of the described network are wireless devices such as mobile phones, terminals, smart phones, portable computing devices such as lap tops, handheld devices, tablets, netbooks, computers, personal digital assistants and other wireless communication devices, or wired communication devices such as telephones, computing devices such as desktop computers, set-top boxes, and other fixed communication devices.

When a roaming user such as calling party A (or UE A) places a call to the called party B (or UE B) the call set-up process involves an originating call associated with UE A and a terminating call associated with UE B. The terms “originating call” and “terminating call” may comprise or represent the connection set-up and signalling in relation to UE A or UE B, respectively. Examples of originating or terminating calls that may be used in certain embodiments of the described network include, but are not limited to, the connection set-up signalling enabling a communication connection to be made between UE A and UE B in the two call halves model. The originating call is the connection set-up and signalling for UE A in the first call half and the terminating call is the connection set-up and signalling for connecting the call with UE B in the second call half.

Work has started in 3GPP on the aspects of IMS roaming, and the possibility to ensure that current circuit switched (CS) roaming charging and business relationships can be reused (see 3GPP Technical Specification (TS) 23.850v030). To mimic the CS model, it is important to allow the IMS signalling to be routed back to the VPLMN after service execution has been performed in the HPLMN. That way, the VPLMN will be in charge for the call termination, allowing the VPLMN to settle the charges of the terminating network, and to recharge these and its own charges back to the HPLMN. A special aspect of this is the case where the HPLMN actually would like to do the call termination instead of the VPLMN or any other network.

FIG. 1 further illustrates the problems associated with existing IMS roaming architectures, where the solid line extending between user A and user B illustrates the IMS signalling path and the dashed line illustrates the media path. The first problem (Problem 1) illustrates that different business relationship for CS and IMS roaming between HPLMN A and VPLMN A (Home and Visited A) is required, this complicates arrangements between operators and would lead to further infrastructure to handle charging and routing. A second problem (Problem 2) is illustrated in that how does the VLPMN A (visited A) know that VPLMN B (visited B) supports IMS roaming, this means that direct routing of the media from VPLMN A to VPLMN B may not be possible. A third problem identified (Problem 3) is that it is difficult to determine the charging for termination fees from IPXP 1 to IPXP 4, as no signalling traverses this network, which may require new business relationship between carriers and service providers. This further complicates the relationships. Similarly, the fourth problem identified (Problem 4) is based on what grounds will the termination fees be distributed between IPXP3 and IPXP 4. FIG. 2 illustrates the conventional CS roaming architecture, whilst FIG. 3 illustrates a desired IMS roaming architecture which attempts to mimic the CS architecture, where the dashed line indicates IMS signalling and the solid line indicates media. FIG. 3 also illustrates the inter-operator billing model.

Home routing could be done in different ways, and some of these are described in 3GPP TS 23.850v030. FIG. 4 illustrates the case where a call originating in the VPLMN is routed to the HPLMN, then back to the VPLMN, and then back again to the HPLMN. The reason for routing signalling back to VPLMN is to mimic the CS charging model, and also allow potential visited services specific procedures to be applied. In this example, the initial session establishment request (INVITE 1) sent by the UE to the VPLMN does not necessarily contain a globally routable called party identity. As such, the HPLMN must return the INVITE to the VPLMN with the correct identity (as a result of number normalization). The VPLMN can then resend the INVITE with the correct identity. This second session establishment request (INVITE 11) is then accompanied by the media path, i.e. from the VPLMN, via the IPX Proxy, to the HPLMN and onward to any further network. This allows network operators to rely upon existing business models for inter-operator charging. Of course, if the terminating network is a network other than the HPLMN, the second INVITE 11 is forwarded to that other network, allowing media to be established along the same path and allowing existing charging models to be applied.

The problem with the current proposal for home routing for IP networks, based on the tromboning to the VPLMN (FIG. 4), is that the call is not “continuing” in the originating HPLMN and routed onwards as an originating call. Instead it may be more regarded as a transit or terminating case for the call. This also means that charging is more difficult to apply as there would be a need for more off-line correlation of the Charging Data Records (CDRs) to correlate the first INVITE coming from the VPLMN with any second INVITE in relation to the originating call.

Therefore, there is a significant need to provide a mechanism for efficiently handling IMS session establishment of originating calls for roaming users such as, for example, to minimise or even eliminate incorrect routing of the signalling and media paths of originating calls from roaming users. Other needs also include a mechanism providing simpler application of charging and other services in relation the originating calls.

### SUMMARY

It has been recognised here that whilst there are certain mechanisms for IMS routing of an originating call from a visited access network that a calling party (e.g. UE A) is visiting towards a called party or service, none of the relevant standards or systems allow for the home network of the calling party or HPLMN to route the originating call towards the called party while at the same time keeping the same type of business and signalling model as when the visiting network routes the media to the terminating network. The VPLMN should be able to use the same procedures with the anchor function both for a home routing user case and a delegated routing case.

The present invention provides the advantages of allowing IMS roaming for an originating call from roaming UEs to be routed from the visited access network to the home network for further processing to ensure correct service invocation and to provide that the signaling and media paths are set-up to follow the same route. This provides efficient routing of the call and also allows correct charging to be applied by allowing IMS networks by providing the signalling route back to the VPLMN, which allows the service execution to be resumed after the route back to the VPLMN, thereby ensuring that origination charging and services are performed correctly. The present invention also allows IMS networks to, depending on the user profile, directly route the originating call from the home network to the called party, thereby further ensuring that origination services and charging are performed both correctly and efficiently.

According to a first aspect of the invention there is provided a method of operating a first network node in a home network for handling IMS session establishment of an originating call from a UE in a visited access network. The method includes receiving a first session establishment request associated with the originating call, the received first session establishment request including a called party number associated with the originating call. Storing the called party number associated with the first session establishment request. Modifying the first session establishment request by including a routing number identifying the first network node in the request. Transmitting the modified first session establishment request towards the visited access network for further originating call processing.

Optionally, the method includes receiving a further session establishment request including the routing number identifying the first network node. Retrieving the called party number associated with the further session establishment request. Modifying the further session establishment request by including the called party number in the request. Forwarding the modified further session establishment request to a second network node in the home network configured for use in resuming service execution of services associated with the originating call.

Optionally, the method further includes determining whether home routing of the originating call via the visited access network is required, and generating the routing number when home routing of the originating call is required when the session establishment request associated with the originating call is initially received. As an option, determining whether home routing is required is based on the user profile associated with the first session establishment request. Alternatively or additionally, the method further includes determining whether direct home routing of the originating call is required when the session establishment request associated with the originating call is initially received, and transmitting the first session establishment request to the second network node in the home network configured for use in resuming service execution of services associated with the originating call.

Optionally, the step of modifying the first session establishment request further includes substituting the called party number with the routing number identifying the first network node. Additionally or alternatively, the step of retrieving the called party number further includes correlating the further session establishment request with a previous received session establishment request associated with the originating call, where the correlation is performed based on at least one of: the routing number, the called party number; and/or a session identity associated with the session establishment requests.

As an option, when the further session establishment request includes the routing number identifying the first network node, then the step of modifying includes substituting the routing number identifying the first network node with the called party number. Alternatively or additionally, the first network node includes the functionality of an application server. Alternatively or additionally, the second network node includes the functionality of a call session control function (CSCF) or a serving CSCF. As an option, the session initiation request is a SIP INVITE request message. The called party number may be included in the URI of the SIP INVITE request message.

According to a second aspect of the invention there is provided a method of operating a second network node in a home network for handling IMS session establishment of an originating call from a UE in a visited access network. The method includes receiving a first session establishment request associated with the originating call. The first session establishment request including a called party number associated with the call. The method includes determining whether the UE is visiting the access network. When the UE is visiting the access network, the method further includes performing the steps of: forwarding the first session establishment request associated with the originating call to a first network node configured for handling roaming UEs or UEs visiting the visited access network; suspending execution of service invocation of the originating call associated with the UE; receiving a second session establishment request from the first network node, the second session establishment request associated with the originating call; and performing execution of service invocation of the originating call associated with the UE based on the second session establishment request.

As an option, the step of performing execution of service invocation of the originating call further includes anchoring the originating call within the home network and performing routing of a terminating call associated with the originating call. Additionally or alternatively, the second network node includes the functionality of a call session control function or serving CSCF. Additionally or alternatively, the first network node includes the functionality of an application server. As an option, the session initiation requests are SIP INVITE request messages including the called party number in the URI.

According to a third aspect of the invention there is provided a method of handling IMS session establishment in a home network of an originating call from a UE in a visited access network. The method includes receiving a session establishment request associated with the originating call, the session establishment request including a called party number. Storing the called party number associated with the session establishment request. Modifying the session establishment request by including a routing number identifying a first network node within the home network in the request. Transmitting the modified session establishment request towards the visited access network.

As an option, the method further includes receiving a second session establishment request associated with the originating call, the second session establishment request including the routing number identifying the first network node in the home network. The called party number associated with the first and second session establishment requests is retrieved. The second session establishment request is modified by including the called party number in the request. Service execution of services associated with the originating call are performed or resumed.

According to a fourth aspect of the present invention there is provided a first network node for use in a home network for handling IMS session establishment of an originating call from a UE in a visited access network. The network node includes a receiver, a transmitter, a memory unit, and processing logic, the processing logic being connected to the receiver, to the transmitter, and to the memory unit. The receiver is configured to receive a session establishment request associated with the originating call. The processing logic is configured to determine whether the session establishment request is a first session establishment request associated with the originating call and includes a called party number associated with the call. When the session establishment request corresponds to the first session establishment request, then the processing logic is further configured to: store the called party number associated with the session establishment request; and modify the session establishment request by including a routing number identifying the first network node in the request; and the transmitter is configured to transmit the modified session establishment request towards the visited access network for use in originating call routing of the session.

Optionally, the processing logic is further configured to determine whether the session establishment request is a second session establishment request associated with the originating call and includes a routing number identifying the first network node. When the session establishment request corresponds to the second session establishment request, then the processing logic is further configured to: retrieve the called party number associated with the session establishment request; and modify the session establishment request by including the called party number in the request; and the transmitter is further configured to transmit the modified session establishment request to a second network node in the home network configured for use in executing service invocation for the originating call.

According to a fifth aspect of the invention, there is provided a second network node for use in a home network for handling IMS session establishment of an originating call from a UE in a visited access network. The second network node includes a receiver, a transmitter, a memory unit, and processing logic, the processing logic being connected to the receiver, to the transmitter, and to the memory unit. The receiver is configured to receive a first session establishment request associated with the originating call, the first session establishment request including a called party number associated with the call. The processing logic is configured to determine whether the UE is visiting the access network. When the UE is visiting the visited access network, the processing logic is further configured to: forward, via the transmitter, the first session establishment request associated with the originating call to a first network node configured for handling UEs visiting the visited access network; suspend execution of service invocation of the originating call associated with the UE; receive, from the receiver, a second session establishment request from the first network node, the second session establishment request associated with the originating call; and resume execution of service invocation of the originating call associated with the UE based on the second session establishment request.

According to a sixth aspect of the invention there is provided a home network configured to handle IMS session establishment of an originating call from a UE in a visited access network. The home network configured to receive a session establishment request associated with the originating call, the session establishment request including a called party number, store the called party number associated with the session establishment request, modify the session establishment request by including a routing number identifying a first network node within the home network in the request, and transmit the modified session establishment request towards the visited access network.

As an option, the home network is further configured to receive a second session establishment request associated with the originating call, the second session establishment request including the routing number identifying the first network node in the home network, retrieve the called party number associated with the first and second session establishment requests, modify the second session establishment request by including the called party number in the request, and perform service execution of services associated with the originating call based on the second session establishment request.

The invention provides the advantages of allowing IMS roaming for an originating call from roaming UEs to be routed from the visited access network to the home network for further processing to ensure correct service invocation and to provide that the signaling and media paths are set-up to follow the same route. This provides efficient routing of the call and also allows correct charging to be applied to the call. It further provides a consistent mechanism for the routing of the call by ensuring that the VPLMN will always be included in the routing decision and the exact same charging principles apply irrespective of the HPLMN deciding to anchor the calls or traffic in the home network or whether onward routing of the call is delegated to the VPLMN.

### BRIEF DESCRIPTION OF THE DRAWINGS

In order that the invention may be more fully understood, some of the embodiments of the invention will now be described, by way of example only, with reference to the accompanying drawings, in which:

FIG. 1 is a schematic illustration of the problems associated with existing IMS roaming architectures;

FIG. 2 is a schematic illustration of the conventional CS roaming architecture;

FIG. 3 is a schematic illustration of an IMS roaming architecture and inter-operator billing model for IMS routing of an originating call associated with a roaming calling party A;

FIG. 4 is a signalling flow diagram of an IMS routing case where a call originating in a VPLMN is routed to the HPLMN;

FIG. 5 is a schematic illustration of the signalling (dashed line) and media paths (solid line) for routing an originating call according to the invention;

FIG. 6 is a signalling flow diagram illustrating an example of routing an originating call according to the invention;

FIG. 7a is a flow diagram illustrating an example process in a home network or HPLMN for use in routing an originating call according to the invention;

FIG. 7b is a flow diagram illustrating another example process in the home network for use in routing an originating call according to the invention;

FIG. 7c is a flow diagram illustrating a further example process for use in routing an originating call according to the invention;

FIG. 8a is a schematic illustration of an example communication system according to the invention;

FIG. 8b is a schematic illustration of an example user equipment according to the invention;

FIG. 8c is a schematic illustration of an example implementation of one or more network nodes in a base station according to the invention;

FIG. 9a is a schematic illustration of an example network node according to the invention; and

FIG. 9b is a schematic illustration of another network node according to the invention.

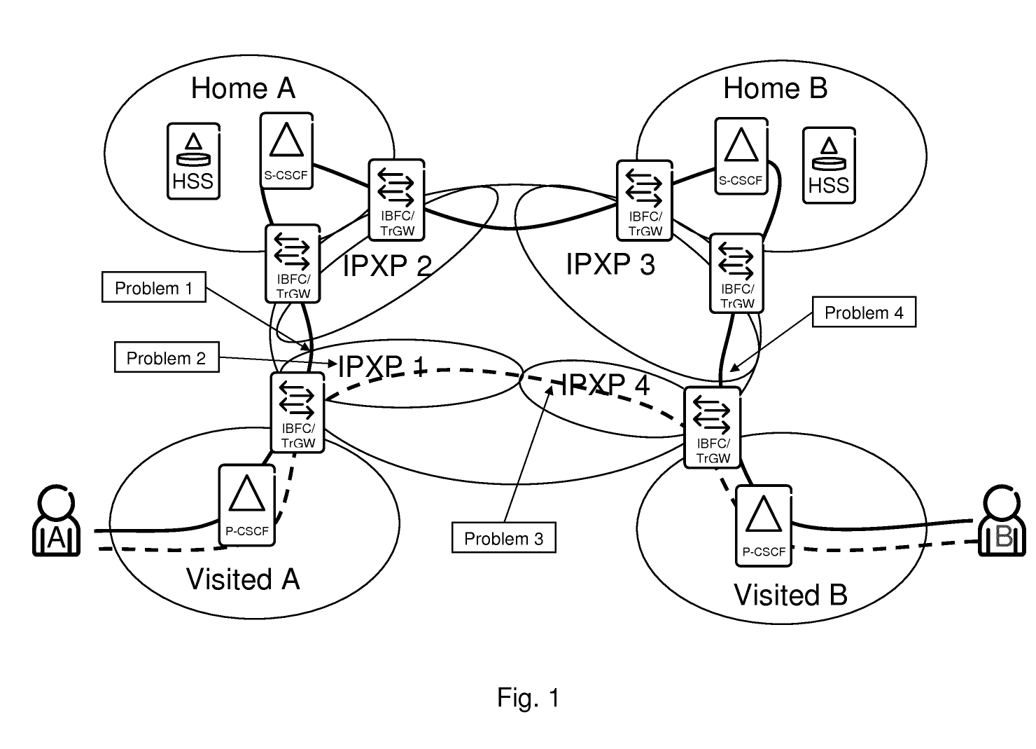

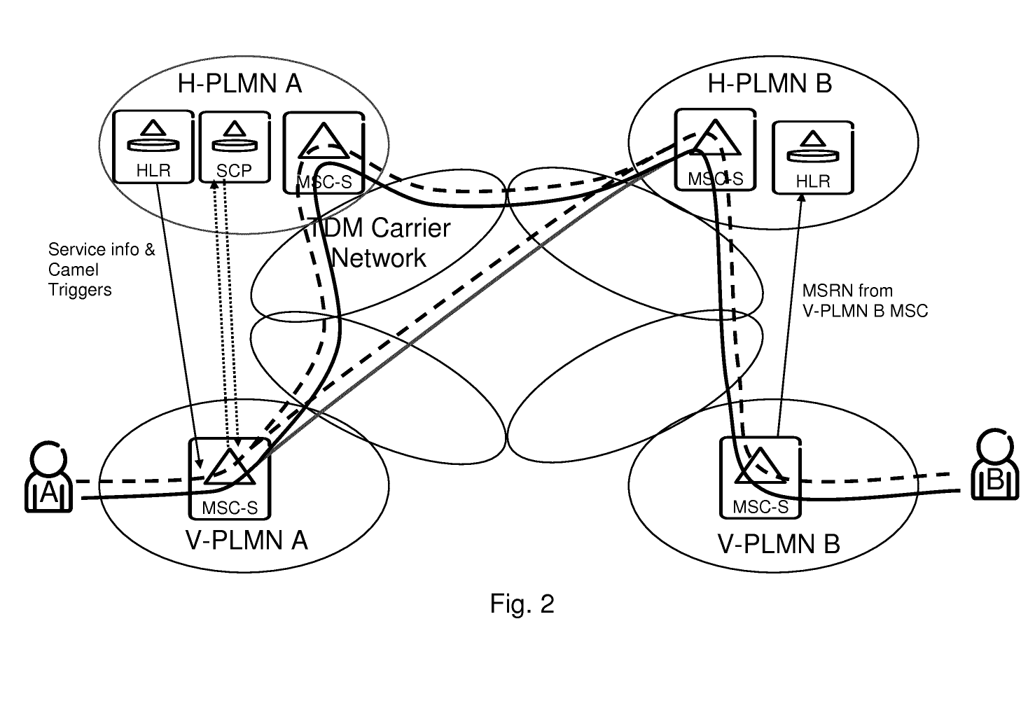

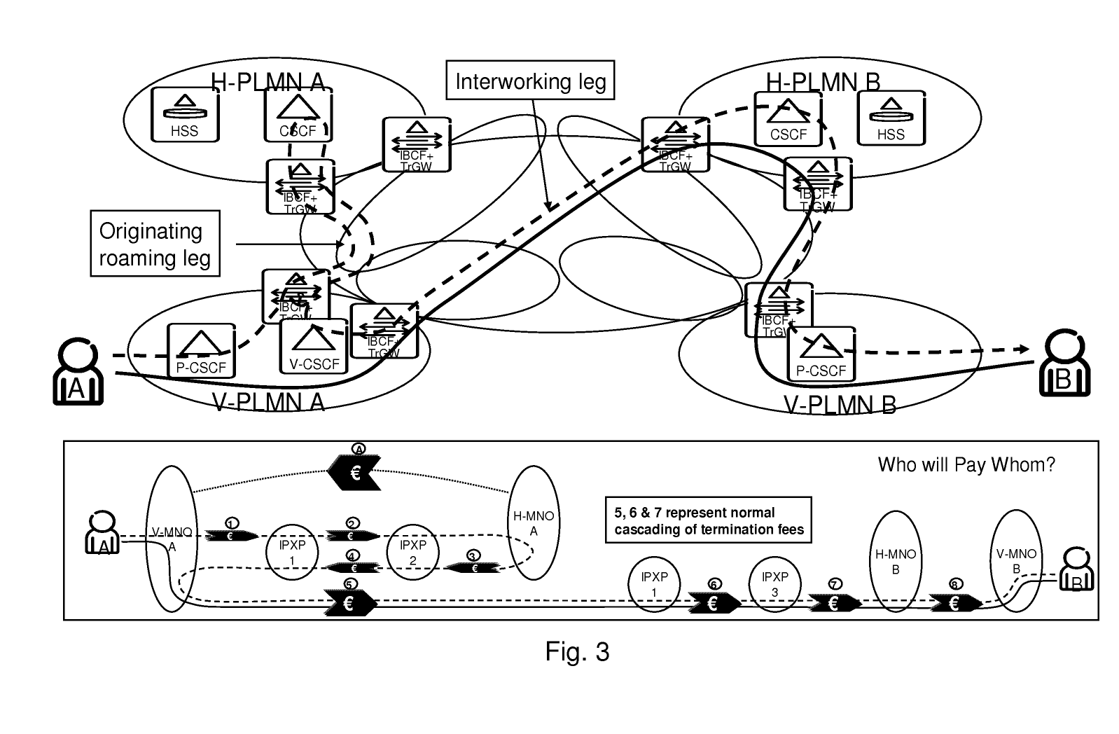

### DETAILED DESCRIPTION

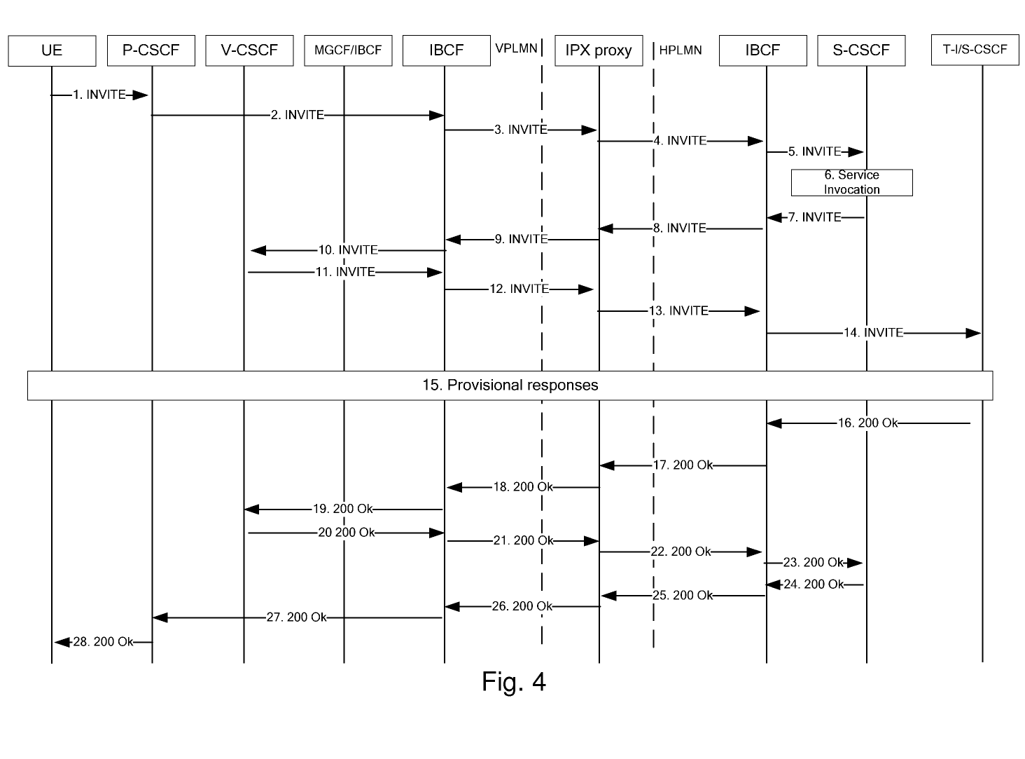

In order to overcome the problems identified above with IMS roaming, methods and apparatus or nodes are described for use in handling IMS session establishment for a roaming user in IMS networks. In the scenario illustrated in FIG. 4, the HPLMN treats the call like a terminating call and will invoke the appropriate service accordingly. It may however be preferable to treat the call as an originating call given that the subscriber (i.e. UE) is a subscriber of the HPLMN. It is further noted that the existing proposals may allow the second INVITE sent by the VPLMN (i.e. INVITE 11 in FIG. 4) to be sent to some network other than the subscriber's HPLMN. This may happen where the subscriber's number has been ported from an old HPLMN to a new HPLMN, and the VPLMN has no knowledge of this porting. It is desirable in such cases to allow the new HPLMN (which received the first INVITE 1) to force the VPLMN to send the second INVITE 11 to the new HPLMN. It may also be desirable to allow the HPLMN to force the VPLMN to send the second INVITE 11 to it, even where the destination network is a network other than that HPLMN.

According to embodiments of the present invention, when a user of a UE initiates a call to a called party, an IMS session establishment request including a called-party destination address, for example a SIP INVITE, is sent by the visited access network (visited network) to the user's home network. Upon receipt of the request in the home network, an IMS network node such as a CSCF, e.g. an S-CSCF, of the home network initiates service invocation, including forwarding the request to an AS responsible for roaming services. The AS stores the original called-party number from the originating request and includes a routing number in the request, identifying the AS within the home network, and causes the request to be returned to the visited network. Upon receipt of the returned request within the visited network, the visited network performs originating call routing of the session and media based on the routing number. The request is then routed to the AS in the home network identified by the routing number, with the AS correlating the received request with the earlier received request, substituting the routing number for the original called-party destination address, and forwarding the request to the CSCF where service invocation is resumed and completed.

An advantage of this approach results in the home network being able to invoke all appropriate services for the roaming calling party or UE, in the same way as would be done for the non-roaming case.

In order to implement the proposed methods and apparatus, new functionality is added to nodes within the home and visited network. For example, within the home network, an S-CSCF may be configured to forward the initial session establishment request to the roaming AS, and to suspend invocation of the service until a further session establishment request is received. The roaming AS, which may be a modified SCC-AS, may be configured to receive the request from the S-CSCF, store the original called-party number, include the roaming number instead of the original called-party number, and return the request to the visited network. Upon the return of the request, the AS correlates the request with the original request, performs the number substitution of the roaming number with the original called-party number, and sends the request to the S-CSCF.

Within the visited network, a modified CSCF, e.g. a Visited CSCF (V-CSCF) or Transit function may be configured to receive the returned request from the AS in the home network, and perform originating call routing of the session and the media based on the routing number, and to forward the request back to the AS.

The present invention provides a mechanism to provide home routing for an AS whilst:
temporarily stopping service execution while performing the routing back through the VPLMN,
storing the called-party number and adding a routing number to the request prior to routing it back to the VPLMN, and
when the request is returned back to the application service, the called-party number is restored and current service execution for the call is resumed.

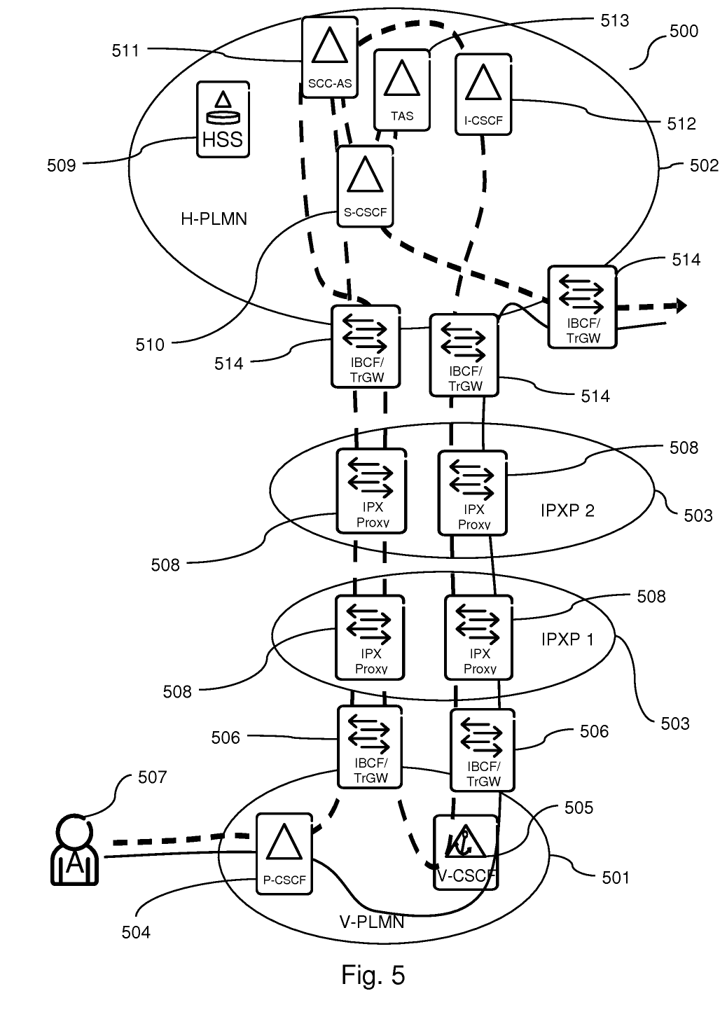

FIG. 5 is a schematic illustration of a communication network 500 comprising a V-PLMN 501 and an H-PLMN 502 in communication via IPX networks 503. The signalling (dashed line) and media paths (solid line) for routing an originating call according to the invention are also shown. V-PLMN 501 includes various IMS network nodes such as a P-CSCF/AGW 504, Visiting CSCF 505, and IBCF/TrGW nodes 506. A calling party A, e.g. UE A 507 is shown to be visiting V-PLMN 501. The IPX networks 503 include various nodes such as IPX proxies 508. The H-PLMN 502 includes various IMS nodes and servers such as HSS 509, S-CSCF 510, SCC-AS 511, I-CSCF 512, Telephony Application Server (TAS) 513 and various IBCF/TrGW nodes 514.

The key aspect is the use of an AS in HPLMN 502 (e.g., reusing an existing AS such as SCC AS 511) which, based on the user profile (stored in HSS 509), “breaks” the current service execution, and routes back the originating call to the anchor node in the VPLMN 501 (e.g., V-CSCF 505 or a Transit function) or visited access network that the user is visiting. The AS stores the called-party number and adds a routing number such that the anchor in the VPLMN 501 can send the call back to the AS in the home network 502. When the call is routed back to the AS, the AS restores the called-party number and resumes the service execution, and returns the call to the S-CSCF 510 so that the S-CSCF 510 can continue to invoke additional services as per normal procedures.

In particular, UE-A or calling party A 507 originates a call such that the P-CSCF 504 of the VPLMN 501 receives the initial session establishment request (e.g. SIP INVITE) associated with the originating call. As UE-A 507 is a roaming user, the P-CSCF 504 of the VPLMN 501 forwards the initial session establishment request to the Home PLMN 502 or home network for UE-A 507 via corresponding IBCF/TrGWs 514 and IPX proxies 508. An S-CSCF 510 in the home network 502 is configured to forward the initial session establishment request to the roaming AS and to suspend invocation of the service until the further request is received. As illustrated, the roaming AS is a modified SCC-AS 511, and based on the user profile, the SCC-AS 511 decides whether Home routing is needed. If Home routing is needed, the SCC-AS 511 generates a routing number, stores the original called-party number (B-Party address) within the initial session request, and returns the session establishment request modified to include the generated routing number to the VPLMN 501. The modified session establishment request is directly forwarded to the VPLMN 501. When the session establishment request returns from the SCC-AS 511 of the HPLMN 502, a V-CSCF 505 of the VPLMN 501 performs originating call routing of the session and media based on the B-Part address, which in this case is now the generated routing number. The session establishment request is returned to the HPLMN 501, which is received by the I-CSCF 512 and based on the routing number, the session establishment request is returned to the SCC-AS 511, which re-instates the stored original B-Party address or called-party number. The SCC-AS 511 returns the session request to the S-CSCF 510 over the ISC Interface. SDP now also indicates that media is anchored in the HPLMN 502. On receipt of the session request from the SCC-AS 511, the S-CSCF 510 resumes invocation of the service. After executing originating services in TAS 513, the HPLMN 502 does not route the session to the VPLMN 501, as the media is already anchored in the HPLMN 502 according to SDP. The originating call is then routed from the HPLMN 502 to VPLMN B (not shown), in which the media is “anchored” in every network that the originating call traverses, i.e. follows the path of the call setup and signalling (a call chain).

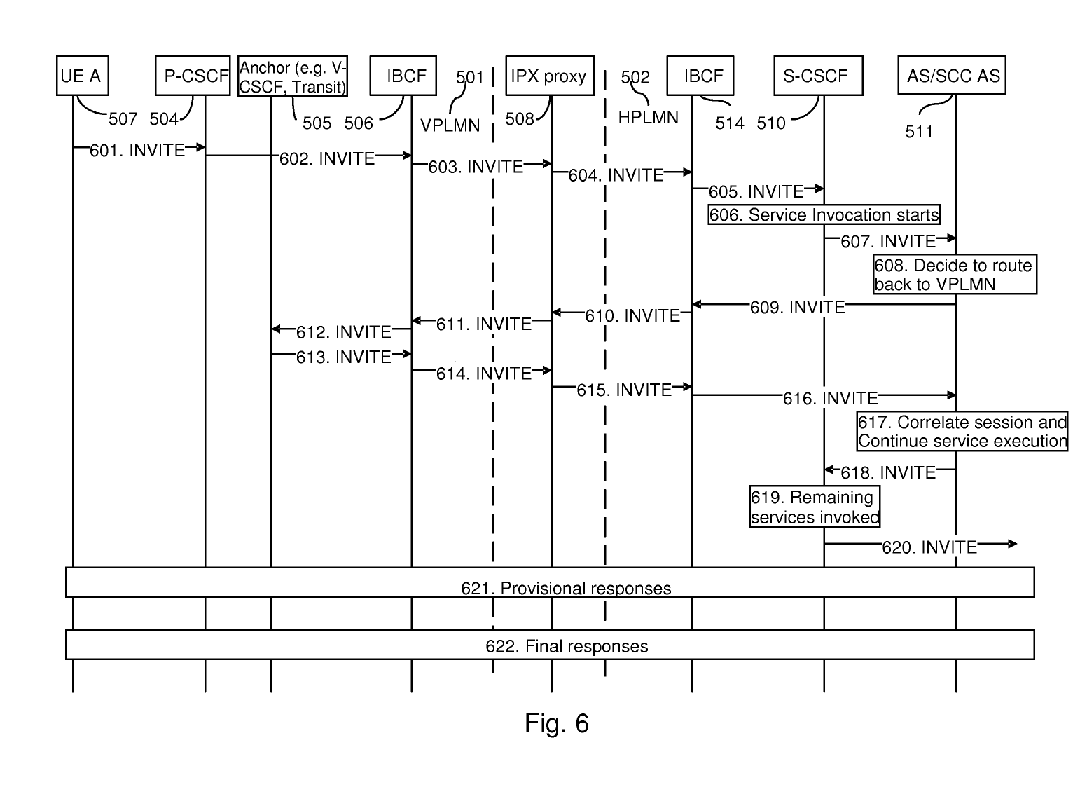

FIG. 6 is a signalling flow diagram illustrating an example of routing an originating call according to the invention. The same reference numerals used in FIG. 5 will be referred to when describing the same or similar network elements or nodes. Referring now to FIG. 6, this illustrates the following procedure.
601-605. The UE 507 initiates a session or call, in which an INVITE (session establishment request) is routed to its S-CSCF 510 in the home network 501 (as per standard procedures).
606. The S-CSCF 510 starts the service invocation and sends the INVITE to the Home Routing AS 511.
607. The AS 511 handling the VPLMN routing is included as a first AS 511 in the chain of application servers, and the S-CSCF 510 forwards the request (INVITE) to the AS 511.
608. Based on the user profile, the AS 511 decides that Home routing is required and generates a routing number. The AS 511 stores the current called-party number for the session. The routing number is added to the request i.e. INVITE (as B party address/called party number), which is then returned to the anchoring function (e.g. V-CSCF 505) in the VPLMN 501 (the anchoring function is known either by configuration or due to that it was explicitly added to the request (INVITE) by the VPLMN 501 in step 602/603).
609-612. The call is routed back to the VPLMN 501. [It will be appreciated that, according to previous proposals, the returned INVITE (session establishment request) contained the actual, globally routable called party identity rather than a routing number identifying the AS 511 as is the case here.]
613. When the session (INVITE) is returned from the HPLMN 502, the anchor function (e.g. V-CSCF 505) in the VPLMN 501 performs originating call routing of the session and the media based on the B-Part address. In this case the routing number identifying the AS 511 in the HPLMN 502.
614-616. The call (INVITE) is forwarded back to the HPLMN 502. As the routing number points to the AS 511, the call is forwarded directly to the AS 511. Thus, the signalling is forced back to the HPLMN 502 and cannot be routed to another network as might otherwise be the case, e.g. where the UE's 507 number has been ported to the HPLMN 502 from another network.
617. The AS 511 receives the request (INVITE) and correlates it with the previous request (INVITE) received in step 607. Correlation may be done on e.g., the routing number only, or a combination of the routing number, calling party identity, and session identity. The AS 511 reinstates the original B-party address stored and continues any service execution required. The SDP now also indicates that media is anchored in the HPLMN 502.
618. The AS 511 returns the session (INVITE) to the S-CSCF 510 over ISC.
619-620. The S-CSCF 510 resumes the service execution of other services, such as the telephony application services. After executing the remaining originating services, the HPLMN 502 does not route the session (INVITE) to the VPLMN 501, as the media already is anchored in the HPLMN 502 according to the SDP. Instead, normal terminating routing is performed.

The VPLMN is able to use the same procedures with the anchor function both for the home routing use case, and the delegated routing case. The procedure as described mimics the CS charging model by providing the signalling route back to the VPLMN. It also allows service execution to be resumed after the route back to the VPLMN, thereby ensuring that origination charging and services are performed correctly.

It is further noted that, as the approach of FIG. 6 completes the service invocation in the HPLMN 502 only in response to receipt by the HPLMN 502 of the returned INVITE (613 to 616), step 619 in FIG. 6, any early media such as ring tones and service announcements will be included (as SDP) in the 200 OK response to that INVITE. In contrast, with the process illustrated in FIG. 4, the early media is provided in the 200 OK response to the first INVITE (601 to 605). The process of FIG. 6 is also advantageous as it conforms more closely to the CS business models.

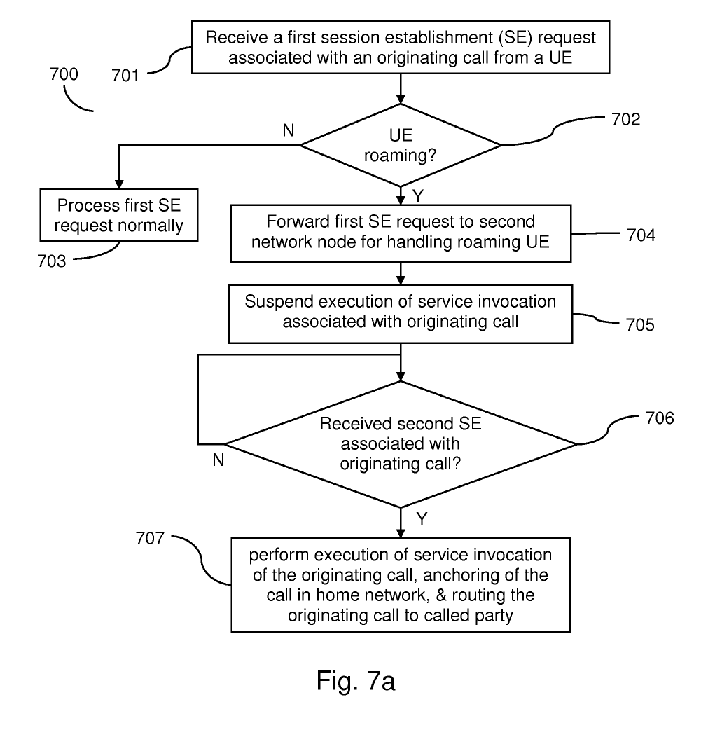

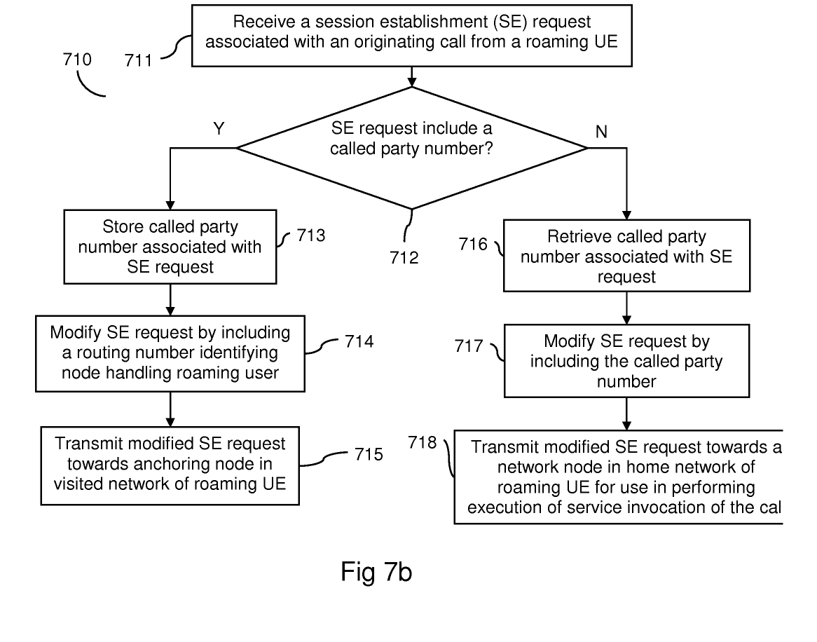

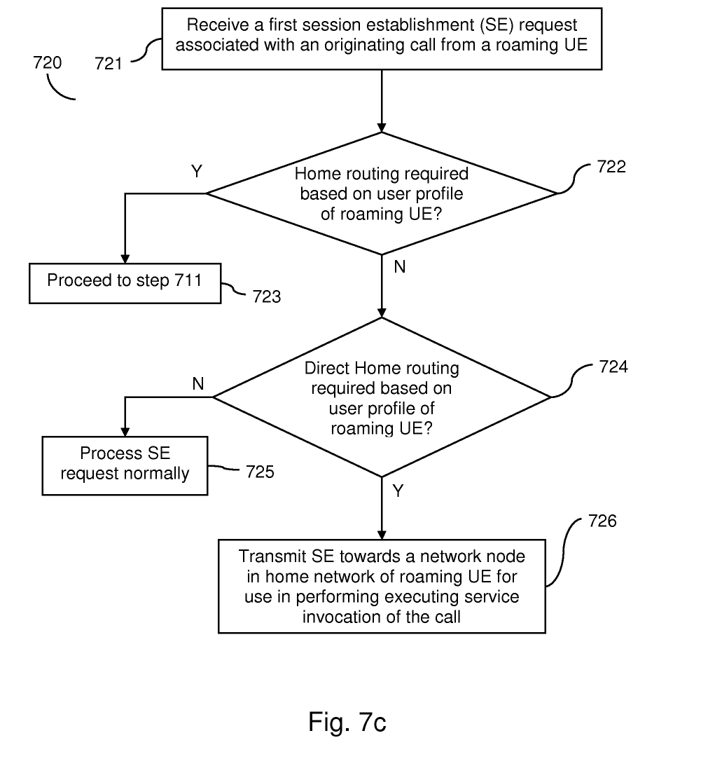

FIG. 7a is a flow diagram illustrating an example process 700 for routing an originating call according to the invention. The process 700 is a method of operating a network node such as, for example, a CSCF or S-CSCF node in a home network for handling IMS session establishment of an originating call from a user equipment, UE, in a visited access network, the steps performed are as follows:
701. Receiving a first session establishment request associated with the originating call, the first session establishment request including a called party number associated with the call.
702. Determining whether the UE is visiting the access network, i.e. is the UE roaming. If the UE is visiting the access network, then proceed to step 704, otherwise proceed to step 703.
703. Process the session establishment request using normal procedures.
704. Forwarding, when the UE is visiting the access network, the first session establishment request associated with the originating call to a second network node configured for handling UEs visiting the access network. The second network node may be, for example, an AS such as an SCC-AS. Proceed to step 705.
705. Suspending execution of service invocation of the originating call associated with the UE. Proceed to step 706.
706. When a second session establishment request is received from the second network node, which is associated with the originating call, then proceed to step 707, otherwise, wait until receipt of the second session establishment request.
707. Performing execution of service invocation of the originating call associated with the UE based on the second session establishment request.

The process may further include the step of performing execution of service invocation of the originating call further including anchoring the originating call within the home network and performing routing of a terminating call associated with the originating call. The network node may include the functionality of a call session control function. The second network node may include the functionality of an AS (e.g. an SCC-AS).

FIG. 7b is a flow diagram illustrating another example process 710 for routing an originating call according to the invention. The process 710 is a method of operating a network node such as, for example, an AS or SCC-AS in a home network for handling IMS session establishment of an originating call from a UE in a visited access network, the steps performed are as follows:
711. Receiving a session establishment request associated with the originating call. Proceed to step 712.
712. Determining whether the session establishment request is a first session establishment request associated with the originating call and includes a called party number associated with the call. If the session establishment request is a first session establishment request associated with the originating call and includes a called party number associated with the call, then proceed to step 713. Otherwise, the session establishment request may be a second session establishment request associated with the originating call and may include a routing number identifying the network node, proceed to step 716.
713. Storing the called party number associated with the session establishment request, when the session establishment request corresponds to the first session establishment request. Proceed to step 714.
714. Modifying the session establishment request by including a routing number identifying the network node in the request when the session establishment request corresponds to the first session establishment request.
715. Transmitting the modified session establishment request towards the visited access network for use in further originating call processing (e.g. originating call routing of the session and the media based on the routing number), when the session establishment request corresponds to the first session establishment request.
716. Retrieving the called party number associated with the session establishment request when the session establishment request corresponds to the second session establishment request. Proceed to step 717.
717. Modifying the second session establishment request by including the called party number in the request. Proceed to step 718.
718. Transmitting, when the session establishment request corresponds to the second session establishment request, the modified session establishment request to another network node such as, for example, a CSCF node or S-CSCF node in the home network configured for use in executing service invocation for the originating call.

FIG. 7c is a flow diagram illustrating another example process 720 for routing an originating call according to the invention. The process 720 is a method based on process 710, the steps performed are as follows:
721. Receiving a session establishment request associated with the originating call. Proceed to step 722.
722. Determining whether home routing of the originating call via the visited access network is required when a first session establishment request associated with the originating call is received. If home routing of the originating call via the access network is required, then proceed to step 723. Otherwise proceed to step 724.
723. Proceed to step 711. This may also involve generating the routing number.
724. Determining whether direct home routing of the originating call is required when the first session establishment request is received. If direct home routing is required, then proceed to step 726. Otherwise, proceed to step 725.
725. Process the session establishment request normally.
726. Transmitting, when direct home routing is required, the session establishment request to the network node in the home network configured for use in executing service invocation for the originating call.

The processes 710 and 720 may further include determining whether home routing is required based on the user profile associated with the first session establishment request. When the session establishment request corresponds to the first session establishment request, then the step of modifying the session establishment request may further include substituting or replacing the called party number with the routing number identifying a network node in the home network configured for handling roaming UEs (e.g. AS or SCC-AS). When the session establishment request corresponds to the second session establishment request, then the step of retrieving the called party number may further include correlating the second session establishment request with the first session establishment request, where the correlation is performed based on at least one of the routing number, the called party number, or a session identity associated with the originating call associated with the requests. When the session establishment request corresponds to the second session establishment request, then the step of modifying includes substituting or replacing the routing number identifying the network node in the home network configured for handling roaming UEs with the called party number. The network node configured for use in executing service invocation may include the functionality of a CSCF or S-CSCF and the network node configured for handling roaming UEs may include the functionality of an AS or SCC-AS.

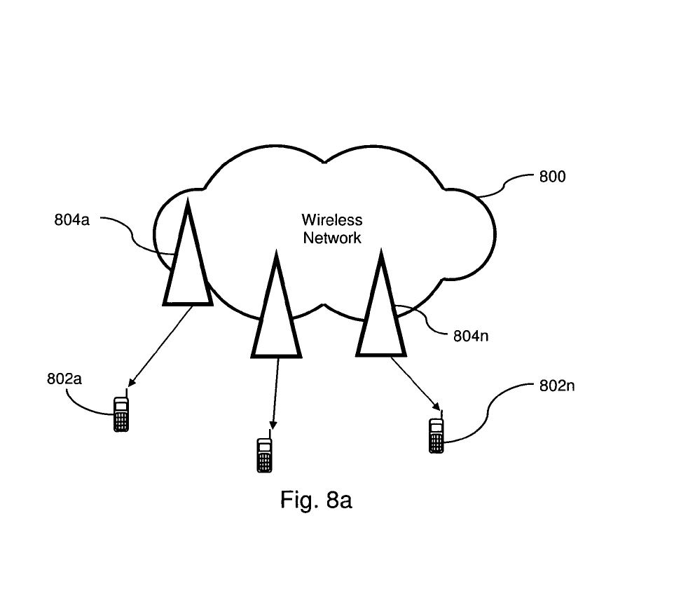

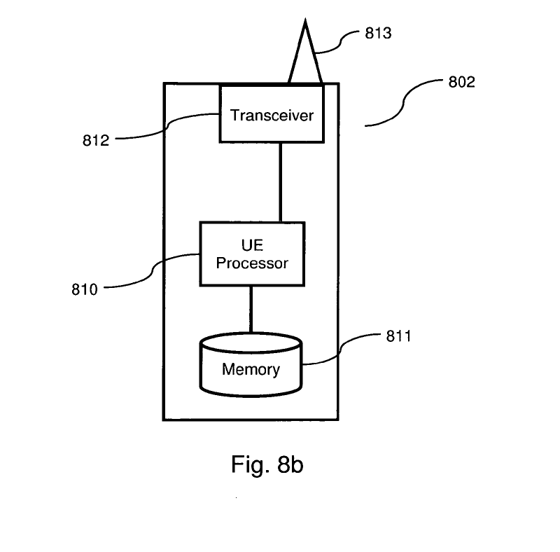

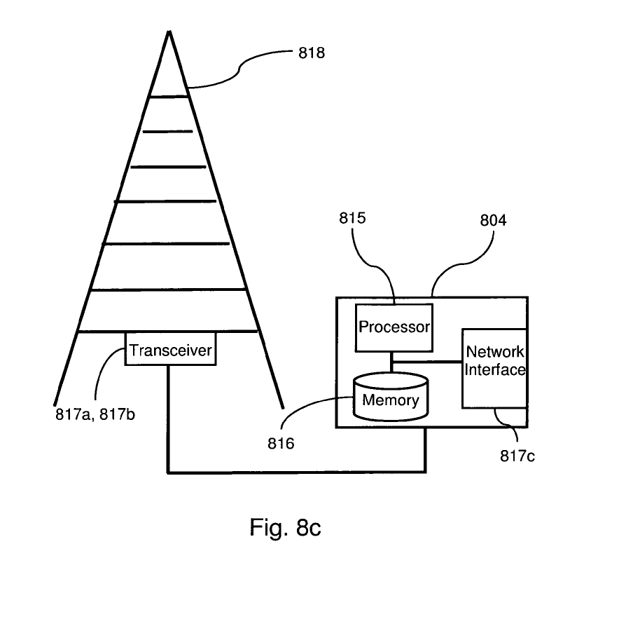

The described solutions may be implemented in any appropriate type of telecommunication system supporting any suitable communication standards and using any suitable components, such as illustrated in FIGS. 8a to 8c.

As shown in FIG. 8a, an example telecommunication system network 800 may include one or more instances of UEs 802a-802n and one or more base stations 804a-804n capable of communicating with these UEs 802a-802n along with any additional elements suitable to support communication between UEs 802a-802n or between a UE 802a and another communication device (not shown) (e.g. a landline telephone). Although the illustrated UEs 802a-802n may represent communication devices that include any suitable combination of hardware and/or software, these UEs 802a-802n may, in particular embodiments, represent devices such as the example UE 507 described with respect to FIG. 5 and, which is, also illustrated in greater detail by FIG. 8b. Similarly, illustrated base stations 804a-804n may represent or include network nodes, such as the network nodes (e.g. P-CSCF 504, V-CSCF 505, S-CSCF 510, SCC-AS 511 etc.) described in FIG. 5, and include any suitable combination of hardware and/or software, these base stations 804a-804n may, in particular embodiments, represent devices such as the example base station (or network node) 804 illustrated in greater detail by FIG. 8c.

The telecommunication network 800 may include a home network (not shown) and a visited access network (not show), where the home network is configured to handle IMS session establishment of an originating call from a UE 802a-802n in the visited access network. The home network may be configured to receive a session establishment request associated with the originating call, the session establishment request including a called party number. The home network may be configured to store the called party number associated with the session establishment request. The home network may be further configured to modify the session establishment request by including a routing number identifying a first network node or base station 804a-804n within the home network in the request and transmit the modified session establishment request towards the visited access network.

In addition, the home network may be further configured to receive a second session establishment request associated with the originating call, the second session establishment request including the routing number identifying the first network node or base station 804a-804n in the home network, retrieve the called party number associated with the first and second session establishment requests, modify the second session establishment request by including the called party number in the request, and perform service execution of services associated with the originating call.

As shown in FIG. 8b, the example UE 802 includes a processor 810, a memory 811, a transceiver 812 and an antenna 813. In particular embodiments, some of all of the functionality described above as being provided by mobile communications devices or other forms of UE may be provided by the UE processor 810 executing instructions stored on a computer-readable medium, such as the memory 811 shown in FIG. 8b. Alternative embodiments of the UE 802 may include additional components beyond those shown in FIG. 8b that may be responsible for providing certain aspects of the UEs functionality, including any of the functionality described above and/or any functionality necessary to support the solution and/or implement embodiments of the invention as described above.

As shown in FIG. 8c, the example base station or network node 804 includes a processor or processing logic 815, a memory 816, transceiver 817a, 817b and network interface 817c, which may include a receiver and a transmitter, and an antenna 818. The network interface 817c may be used for receiving and transmitting between other base stations or other network nodes in the telecommunications network 800. In particular embodiments, some or all of the functionality described above as being provided by a mobile base station, a base station controller, a node B, an enhanced node B, and/or any other type of mobile communications node may be provided by the base station processor 815 executing instructions stored on a computer-readable medium, such as a memory 816 shown in FIG. 8c. Alternative embodiments of the base station may include additional components responsible for providing additional functionality, including any of the functionality identified above and/or any functionality necessary to support the solution and/or to implement embodiments of the invention as described above.

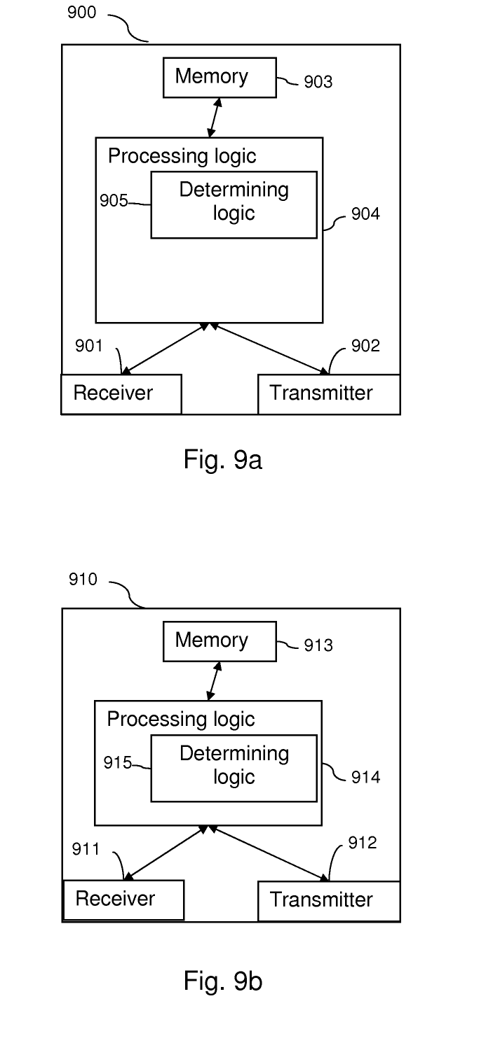

FIG. 9a illustrates an example network node 900 (e.g. a CSCF or S-CSCF) for use in a home network for handling IMS session establishment of an originating call from a UE in a visited access network. The functionality of network node 900 may be included in base station 804 or base stations 804a-804b. Network node 900 comprises a receiver 901, a transmitter 902, a memory unit 903, and processor or processing logic 904, the processing logic 904 being connected to the receiver 901, to the transmitter 902, and to the memory unit 903. In operation, the receiver 901 is configured to receive a first session establishment request associated with the originating call, the first session establishment request including a called party number associated with the call. The processing logic 904 is configured to determine 905 whether the UE is visiting the visited access network. When the UE is visiting the visited access network, the processing logic 904 is configured to a) forward, via the transmitter 902, the first session establishment request associated with the originating call to a second network node (e.g. network node 910 or SCC-AS 511) configured for handling roaming UEs or UEs visiting the visited access network, b) suspend execution of service invocation of the originating call associated with the UE, c) receive, from the receiver 901, a second session establishment request from the second network node (e.g. network node 910 or SCC-AS 511), the second session establishment request associated with the originating call, and d) resume execution of service invocation of the originating call associated with the UE based on the second session establishment request.

FIG. 9c illustrates another example network node 910 (e.g. an AS or SCC-AS) for use in a home network for handling IMS session establishment of an originating call from a UE in a visited access network. The functionality of network node 910 may be included in base station 804 or base stations 804a-804b. The network node 910 includes a receiver 911, a transmitter 912, a memory unit 913, and processing logic or processor 914, the processing logic 914 being connected to the receiver 911, to the transmitter 912, and to the memory unit 913. In operation, the receiver 911 is configured to receive a session establishment request associated with the originating call. The processing logic 914 is configured to determine 915 whether a) the session establishment request is a first session establishment request associated with the originating call and including a called party number associated with the call or b) the session establishment request is a second session establishment request associated with the originating call and including a routing number identifying network node 910.

When the session establishment request corresponds to the first session establishment request, then: the processing logic 914 is further configured to: store the called party number associated with the session establishment request (e.g. store in memory 913); and modify the session establishment request by including a routing number identifying the network node 910 (e.g. AS or SCC-AS) in the request. The transmitter 912 is configured to transmit the modified session establishment request towards the visited access network for further call processing (e.g. originating call routing of the session and media paths based on the routing number and processing of other services).

When the session establishment request corresponds to the second session establishment request, then: the processing logic 914 is further configured to: retrieve the called party number associated with the session establishment request; and modify the session establishment request by including the called party number in the request. The transmitter 912 is further configured to transmit the modified session establishment request to another network node 900 (e.g. a CSCF or S-CSCF) in the home network configured for use in executing service invocation for the originating call.

The network nodes 900 and/or 910 as herein described can include memory units 903 and 913 and processing logics 904 and 914, which can be used for storing and executing a computer program, comprising computer readable code which, when executed by the processing logics 904 and 914, respectively, causes the network node(s) 900 and/or 910 to perform the relevant methods, procedures, or processes of the invention as described herein. Such computer programs as described herein can be incorporated within one or more computer program products, each comprising a computer readable medium and one or more of the computer programs, where one or more of the computer programs are stored on the computer readable medium.

It will be appreciated by the person of skill in the art that various modifications may be made to the above described examples and/or embodiments without departing from the scope of the present invention.

1. A method in a first network node in a home network for handling Internet Protocol Multimedia Subsystem (IMS) session establishment of an originating call from a user equipment (UE) in a visited access network, wherein the first network node includes the functionality of an application server, the method comprising:
receiving a first session establishment request associated with the originating call, the first session establishment request including a called party number associated with the originating call;
storing the called party number associated with the first session establishment request;
modifying the first session establishment request by including a routing number identifying the first network node in the first session establishment request; and
transmitting the modified first session establishment request towards the visited access network for use in further originating call processing.

2. The method according to claim 1, further comprising:
receiving a further session establishment request associated with the originating call, the further session establishment request including the routing number identifying the first network node;
retrieving the called party number associated with the further session establishment request;
modifying the further session establishment request by including the called party number in the further session establishment request; and
transmitting the modified further session establishment request to a second network node in the home network for use in resuming service execution of services associated with the originating call, wherein the second network node includes the functionality of a call session control function.

3. The method according to claim 1, further comprising:
determining whether home routing of the originating call via the visited access network is required; and
generating the routing number when home routing of the originating call is required.

4. The method according to claim 3, wherein the determining whether home routing is required is based on a user profile associated with the first session establishment request.

5. The method according to claim 2, further comprising determining whether direct home routing of the originating call is required, and transmitting the first session establishment request to the second network node in the home network configured for use in resuming service execution of services associated with the originating call.

6. The method according to claim 1, wherein the modifying the first session establishment request further comprises substituting the called party number with the routing number.

7. The method according to claim 2, wherein the retrieving the called party number further comprises correlating the further session establishment request with a previously received session establishment request associated with the originating call, wherein the correlation is performed based on at least one of:
the routing number;
the called party number; and
a session identity associated with the session establishment requests.

8. The method according to claim 2, wherein when the further session establishment request includes the routing number, the modifying the further session further comprises substituting the routing number with the called party number.

9.-10. (canceled)

11. The method according to claim 1, wherein the session establishment requests are Session Initiation Protocol INVITE request messages.

12. A method in a second network node in a home network for handling Internet Protocol Multimedia Subsystem (IMS) session establishment of an originating call from a user equipment (UE) in a visited access network, wherein the second network node includes the functionality of a call session control function, the method comprising:
receiving a first session establishment request associated with the originating call, the first session establishment request including a called party number associated with the call;
determining whether the UE is visiting the access network; and
when the UE is visiting the access network,
forwarding the first session establishment request associated with the originating call to a first network node configured for handling roaming UEs, wherein the first network node includes the functionality of an application server;
suspending execution of service invocation of the originating call associated with the UE;
receiving a further session establishment request associated with the originating call from the first network node; and
performing execution of service invocation of the originating call associated with the UE based on the further session establishment request.

13. The method according to claim 12, wherein the performing execution of service invocation of the originating call further includes anchoring the originating call within the home network and performing routing of a terminating call associated with the originating call.

14. (canceled)

15. The method according to claim 12, wherein the session establishment requests are Session Initiation Protocol INVITE request messages.

16.-18. (canceled)

19. A first network node for use in a home network for handling Internet Protocol Multimedia Subsystem (IMS) session establishment of an originating call from a user equipment (UE) in a visited access network, the first network node comprising:
a receiver, a transmitter, a memory unit, and processing logic, the processing logic being connected to the receiver, to the transmitter, and to the memory unit, wherein the first network node includes the functionality of an application server, and
wherein:
the receiver is configured to receive a session establishment request associated with the originating call;
the processing logic is configured to determine whether the session establishment request is a first session establishment request associated with the originating call and includes a called party number associated with the call, and
when the session establishment request corresponds to the first session establishment request, then:
the processing logic is further configured to:
store the called party number associated with the session establishment request; and
modify the session establishment request by including a routing number identifying the first network node in the request; and
the transmitter is configured to transmit the modified session establishment request towards the visited access network for use in further originating call processing.

20. The first network node according to claim 19, wherein the processing logic is further configured to determine whether the session establishment request is a second session establishment request associated with the originating call and includes the routing number identifying the first network node, and
when the session establishment request corresponds to the second session establishment request, then:
the processing logic is further configured to:
retrieve the called party number associated with the session establishment request; and
modify the session establishment request by including the called party number in the request; and
the transmitter is further configured to transmit the modified session establishment request to a second network node in the home network configured for use in executing service invocation for the originating call, wherein the second network node includes the functionality of a call session control function.

21. A second network node for use in a home network for handling Internet Protocol Multimedia Subsystem (IMS) session establishment of an originating call from a user equipment (UE) in a visited access network, the second network node comprising:
a receiver, a transmitter, a memory unit, and processing logic, the processing logic being connected to the receiver, to the transmitter, and to the memory unit, wherein the second network node includes the functionality of a call session control function, and wherein:
the receiver is configured to receive a first session establishment request associated with the originating call, the first session establishment request including a called party number associated with the call;
the processing logic is configured to determine whether the UE is visiting the visited access network and,
when the UE is visiting the visited access network, the processing logic is configured to:
forward, via the transmitter, the first session establishment request associated with the originating call to a first network node configured for handling UEs visiting the access network;
suspend execution of service invocation of the originating call associated with the UE;
receive, from the receiver, a second session establishment request from the first network node, the second session establishment request associated with the originating call; and
resume execution of service invocation of the originating call associated with the UE based on the second session establishment request.

22.-23. (canceled)
